(19) United States
(12) Patent Application Publication
(10) Pub. No.: US 2023/0365732 A1
(43) Pub. Date: Nov. 16, 2023

(54) BINDER AND LITHIUM-ION BATTERY COMPRISING SAME

(71) Applicant: Zhuhai CosMX Battery Co., Ltd., Guangdong (CN)

(72) Inventors: Lin CHU, Guangdong (CN); Panlong GUO, Guangdong (CN); Weiping CHEN, Guangdong (CN); Suli LI, Guangdong (CN); Junyi LI, Guangdong (CN)

(21) Appl. No.: 18/225,862

(22) Filed: Jul. 25, 2023

Related U.S. Application Data
(63) Continuation of application No. PCT/CN2022/081026, filed on Mar. 15, 2022.

(30) Foreign Application Priority Data
Mar. 15, 2021 (CN) 2021102765718

(51) Int. Cl. C08F 226/02; C08F 220/56; H01M 4/62; H01M 4/13; H01M 10/0525

(52) U.S. Cl. CPC C08F 226/02; C08F 220/56; H01M 4/622; H01M 4/13; H01M 10/0525

(57) ABSTRACT

The present application provides a binder and a lithium-ion battery including the binder. The binder is rich in amino groups, has strong alkali resistance and is not easy to decompose. Besides, rich amino groups in the binder are prone to form hydrogen bonds, so that the binder more fully coats an active material and can enhance an acting force between the active material and a current collector, improve a peeling strength of an electrode piece, and significantly improve a cycling performance, expansion rate, and rate capability of lithium-ion batteries using the binder.

### CROSS-REFERENCE TO RELATED APPLICATIONS

This application is a continuation of International Application No. PCT/CN2022/081026, filed on Mar. 15, 2022, which claims priority to Chinese Patent Application No. 202110276571.8, filed on Mar. 15, 2021. The disclosures of the aforementioned applications are hereby incorporated by reference in their entireties.

### TECHNICAL FIELD

The present application relates to the technical field of lithium-ion batteries, and in particular, to a binder and a lithium-ion battery including the binder.

### BACKGROUND

A binder as a polymer in a lithium-ion battery not only plays a bonding role between active material layers, but also may be used for bonding between an active material layer and a substrate of electrode piece. It plays an important role in manufacture and performance of the battery and is one of important components of the battery.

Polyacrylamide type binder contains a large amount of amino groups, which functional group has strong polarity, good adhesion to copper foil, and strong hydrogen bonding. It has been applied in the field of lithium-ion batteries, such as BM-1100H from Zeon and LA133 from Chengdu Indigo Company. The polymeric monomers of these products all contain amide groups. However, due to easy decomposition of the amide group in polyacrylamide type binder under alkaline conditions (the amide group is easy to hydrolyze under an alkaline condition, producing ammonia and carboxylate), there is a problem of poor alkali resistance and there is a risk of decomposition and gas production (ammonia) in a process of practical application. In order to effectively solve the above problems, it is extremely important to develop a polymer that retains a large number of stable amino groups and be able to avoid the risk of decomposition.

### SUMMARY

In order to solve the shortcomings of weak alkali resistance and easy decomposition of amide groups in polyacrylamide in the prior art, the present application provides a binder and a lithium-ion battery including the binder. The binder is rich in free amino groups which are directly connected to alkyl groups, and has good stability, strong alkali resistance and no decomposition; in addition, the electronegativity of N atom in the free amino group is stronger than that of N atom in amide, which is more conducive to the formation of hydrogen bonds, thereby enhancing the bonding force.

A binder includes at least one polymer which contains a repeating unit shown in Formula 1:

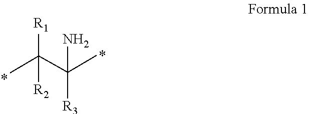

wherein, R₁, R₂, R₃ are the same or different, and are each independently selected from C₁₋₆ alkyl or hydrogen; and * is a connecting end.

According to an embodiment of the present application, the polymer further includes at least one of a repeating unit shown in Formula 2, a repeating unit shown in Formula 3, and a repeating unit shown in Formula 4:

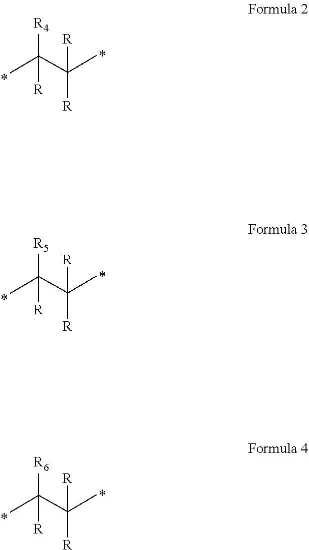

wherein, R₄ is a hydrophilic group, R₅ is a hydrophobic group, and R₆ is an amphiphilic group; each R is the same or different, and is independently selected from an organic group; and * is a connecting end.

According to an embodiment of the present application, the repeating unit of Formula 2 is derived from a hydrophilic monomer; according to another embodiment, the repeating unit of Formula 2 is derived from a hydrophilic monomer containing a carbon-carbon double bond; and according to further another embodiment, the repeating unit of Formula 2 is obtained by free radical copolymerization of a hydrophilic monomer containing a carbon-carbon double bond.

According to an embodiment of the present application, the repeating unit of Formula 3 is derived from a hydrophobic monomer; according to another embodiment, the repeating unit of Formula 3 is derived from a hydrophobic monomer containing a carbon-carbon double bond; and according to further another embodiment, the repeating unit of Formula 3 is obtained by free radical copolymerization of a hydrophobic monomer containing a carbon-carbon double bond.

According to an embodiment of the present application, the repeating unit of Formula 4 is derived from an amphiphilic monomer; according to another embodiment, the repeating unit of Formula 4 is derived from an amphiphilic monomer containing a carbon-carbon double bond; and according to further another embodiment, the repeating unit of Formula 4 is obtained by free radical copolymerization of an amphiphilic monomer containing a carbon-carbon double bond.

Exemplarily, the hydrophilic monomer includes, but is not limited to at least one of (meth)acrylic acid, butenoic acid, itaconic acid, maleic acid, (meth)acrylic salt, butenic salt, itaconic salt, maleic salt, sodium p-styrene sulfonate, sodium vinyl sulfonate, sodium allyl sulfonate, sodium 2-methallyl sulfonate, sodium 2-sulphonatoethyl methacrylate, hydroxyethyl (methyl)acrylate, hydroxypropyl (methyl)acrylate or dimethyl diallyl ammonium chloride and the like. Wherein, the salt mentioned above, for example, is one of lithium salt, sodium salt, and potassium salt.

Exemplarily, the hydrophobic monomer includes, but is not limited to at least one of methyl (meth)acrylate, ethyl (meth)acrylate, butyl (meth)acrylate, vinyl acetate, styrene, acrylonitrile and the like.

Exemplarily, the amphiphilic monomer includes, but is not limited to at least one of stearic acid polyoxyethylene ether (methyl)acrylate, nonylphenol polyoxyethylene ether (methyl)acrylate or dodecyl alcohol polyoxyethylene ether (methyl)acrylate and the like.

According to an embodiment of the present application, the polymer is a homopolymer formed by the repeating unit of Formula 1, or a copolymer formed by the repeating unit of Formula 1 and at least one of the repeating unit of Formula 2, the repeating unit of Formula 3 and the repeating unit of Formula 4;

the repeating unit shown in Formula 2 accounts for 0 to 65 mol % of total moles of the copolymer; and/or the repeating unit shown in Formula 3 accounts for 0 to 20 mol % of total moles of the copolymer; and/or, the repeating unit shown in Formula 4 accounts for 0 to 1 mol % of total moles of the copolymer.

According to an embodiment of the present application, the polymer has a weight average molecular weight of 400,000 to 10,000,000; and/or, the polymer has a decomposition temperature of 320 to 400° C., and a glass transition temperature of 120 to 200° C.

According to an embodiment of the present application, the binder further includes a solvent component selected from water, such as deionized water.

According to an embodiment of the present application, the binder has a solid content of 0.1 to 10 wt %; and/or the binder has a viscosity of 100 to 30000 mPa·s; and/or the binder has a pH value of 5 to 7.

According to an embodiment of the present application, the binder further includes an SBR emulsion-type binder, and an addition amount of the SBR emulsion-type binder is 0 to 60 wt % of a total mass of the binder.

According to an embodiment of the present application, the binder has a peeling strength of 20 N/m or more.

The present application provides an electrode piece, which includes the above-mentioned binder.

According to an embodiment of the present application, the electrode piece includes a current collector and an active material layer located on a surface of at least one side of the current collector, the active material layer includes the above-mentioned binder, and an addition amount of the binder accounts for 0.5 to 5 wt % of a total mass of the active material layer.

The present application provides a lithium-ion battery, which includes the above-mentioned electrode piece.

The present application has beneficial effects as below:

The present application provides a binder and a lithium-ion battery including the binder, where the binder is rich in free amino groups, the amino groups are directly connected to alkyl groups and have good stability, strong alkali resistance and no decomposition. In addition, the abundant free amino groups in the binder are prone to form hydrogen bonds, which makes the binder more fully encapsulate the active material, enhances the action force between the active material and the current collector, improves the peeling strength of the electrode piece, and significantly improves the cycle performance, expansion rate, and rate capability of lithium-ion batteries using the binder. The binder in the present application is obtained through Hoffman degradation or hydrolysis after copolymerization, and the preparation method is simple and easy to achieve.

### BRIEF DESCRIPTION OF DRAWINGS

FIG. 1 is a schematic diagram of a testing device for peeling strength of an electrode piece of the present application.

FIG. 2 is a ¹³C NMR spectrum of a polymer in Example 1.

### DESCRIPTION OF EMBODIMENTS

The present application will be further described in detail below in conjunction with specific examples. It should be understood that the following examples are merely illustrative description and explanation of the present application, and should not be construed as limiting the scope of protection of the present application. All technologies implemented based on the above content of the present application are covered within the scope of protection of the present application.

[Binder]

As mentioned above, the present application provides a binder, the binder includes at least one polymer, and the polymer includes a repeating unit shown in Formula 1:

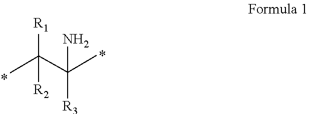

wherein, R₁, R₂, R₃ are the same or different, and are each independently selected from C₁₋₆ alkyl or hydrogen; and * is a connecting end.

According to an embodiment of the present application, R₁, R₂, and R₃ are the same or different, and are each independently selected from C₁₋₃ alkyl or hydrogen.

According to an embodiment of the present application, R₁, R₂, and R₃ are the same or different, and are each independently selected from CH₃ or hydrogen.

According to an embodiment of the present application, the polymer further includes at least one of a repeating unit shown in Formula 2, a repeating unit shown in Formula 3, and a repeating unit shown in Formula 4:

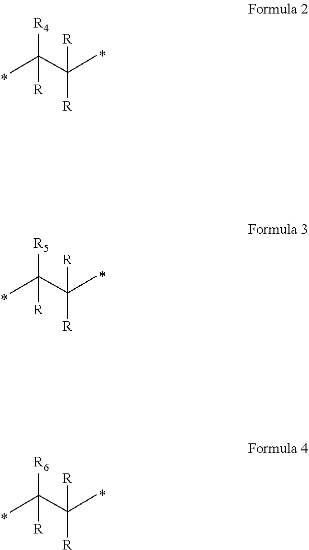

wherein, R₄ is a hydrophilic group, R₅ is a hydrophobic group, and R₆ is an amphiphilic group; each R is the same or different, and is independently selected from an organic group; and * is a connecting end.

According to an embodiment of the present application, the repeating unit of Formula 2 is derived from a hydrophilic monomer; according to another embodiment, the repeating unit of Formula 2 is derived from a hydrophilic monomer containing a carbon-carbon double bond; and according to further another embodiment, the repeating unit of Formula 2 is obtained by free radical copolymerization of a hydrophilic monomer containing a carbon-carbon double bond.

According to an embodiment of the present application, the repeating unit of Formula 3 is derived from a hydrophobic monomer; according to another embodiment, the repeating unit of Formula 3 is derived from a hydrophobic monomer containing a carbon-carbon double bond; and according to further another embodiment, the repeating unit of Formula 3 is obtained by free radical copolymerization of a hydrophobic monomer containing a carbon-carbon double bond.

According to an embodiment of the present application, the repeating unit of Formula 4 is derived from an amphiphilic monomer; according to another embodiment, the repeating unit of Formula 4 is derived from an amphiphilic monomer containing a carbon-carbon double bond; and according to further another embodiment, the repeating unit of Formula 4 is obtained by free radical copolymerization of an amphiphilic monomer containing a carbon-carbon double bond.

According to an embodiment of the present application, the R is selected from a group linked to a carbon-carbon double bond in a hydrophilic monomer, a group linked to a carbon-carbon double bond in a hydrophobic monomer or a group linked to a carbon-carbon double bond in an amphiphilic monomer.

According to an embodiment of the present application, the polymer is a homopolymer formed by the repeating unit of Formula 1, or a copolymer formed by the repeating unit of Formula 1 with at least one of the repeating unit of Formula 2, the repeating unit of Formula 3 and the repeating unit of Formula 4.

Exemplarily, the hydrophilic monomer includes, but is not limited to at least one of (meth)acrylic acid, butenoic acid, itaconic acid, maleic acid, (meth)acrylic salt, butenic salt, itaconic salt, maleic salt, sodium p-styrene sulfonate, sodium vinyl sulfonate, sodium allyl sulfonate, sodium 2-methallyl sulfonate, sodium 2-sulphonatoethyl methacrylate, hydroxyethyl (methyl)acrylate, hydroxypropyl (methyl)acrylate or dimethyl diallyl ammonium chloride and the like. Wherein, the salt mentioned above, for example, is one of lithium salt, sodium salt, and potassium salt.

Exemplarily, the hydrophobic monomer includes, but is not limited to at least one of methyl (meth)acrylate, ethyl (meth)acrylate, butyl (meth)acrylate, vinyl acetate, styrene, acrylonitrile and the like.

Exemplarily, the amphiphilic monomer includes, but is not limited to at least one of stearate polyoxyethylene ether (methyl)acrylate, nonylphenol polyoxyethylene ether (methyl)acrylate or dodecyl alcohol polyoxyethylene ether (methyl)acrylate and the like.

According to an embodiment of the present application, the repeating unit shown in Formula 2 accounts for 0 to 65 mol % of the total moles of the copolymer, exemplarily, 0 mol %, 1 mol %, 5 mol %, 10 mol %, 15 mol %, 20 mol %, 25 mol %, 30 mol %, 35 mol %, 40 ml %, 45 mol %, 50 mol %, 55 mol %, 60 mol %, or 65 mol %. The introduction of the hydrophilic group can provide the binder with more functional groups such as hydroxyl and sulfonic groups, increasing the bonding effect of the binder to the electrode piece and the active material, but content of the hydrophilic group should not be too high, and if it is greater than 65 mol %, the amino content in the binder is low, and the adhesion to the electrode piece is reduced.

According to an embodiment of the present application, the repeating unit shown in Formula 3 accounts for 0 to 20 mol % of the total moles of the copolymer, exemplarily, 0 mol %, 2 mol %, 4 mol %, 6 mol %, 8 mol %, 10 mol %, 12 mol %, 14 mol %, 16 mol %, 18 mol % or 20 mol %. When a molar percentage of the repeating unit shown in Formula 3 is greater than 20 mol %, the copolymer will have a reduced solubility, and is easy to precipitate out during the polymerization process.

According to an embodiment of the present application, the repeating unit shown in Formula 4 accounts for 0 to 1 mol % of the total moles of the copolymer, exemplarily, 0 mol %, 0.1 mol %, 0.2 mol %, 0.3 mol %, 0.4 mol %, 0.5 mol %, 0.6 mol %, 0.7 mol %, 0.8 mol %, 0.9 mol % or 1 mol %. The addition of a small amount of the repeating unit shown in Formula 4 can reduce the effect of surface activity and facilitate the progress of the polymerization reaction.

According to an embodiment of the present application, the weight average molecular weight of the polymer is 400,000 to 10,000,000; according to another embodiment, the weight average molecular weight of the polymer is 800,000 to 3,000,000. Polymers with a molecular weight in this range can meet the controllable adjustment of the adhesive force. If the molecular weight of the polymer is too low, the cohesion between the molecules will be reduced, and the adhesive force will be too low, and if the molecular weight is too high, for example, higher than 10,000,000, the entanglement between molecules will be severe in use, which is not conducive to the adhesion of the active material.

According to an embodiment of the present application, the decomposition temperature of the polymer is 320 to 400° C. (TG test), that is, the polymer will not decompose below 300° C., indicating high thermal stability of the polymer. The glass transition temperature of the polymer is 120 to 200° C. (DSC test), that is, the polymer has a high bonding strength and can endow the binder with good toughness. Especially when the polymer is used with SBR with low glass transition temperature, the electrode piece can maintain a certain degree of toughness.

According to an embodiment of the present application, the binder further includes a solvent component selected from water, such as deionized water. When water is selected as the solvent component, the binder system has solvent-free release, compliance with environmental requirements, non-burning, low cost, safe use, and other characteristics.

According to the embodiment of the present application, the amount of the solvent component added is not specifically limited, as long as the preparation of the binder can be achieved and a binder with specific solid content, viscosity and pH value can be obtained.

According to an embodiment of the present application, the solid content of the binder is 0.1 to 10 wt %; according to another embodiment, the solid content of the binder is 0.3 to 5 wt %.

According to an embodiment of the present application, the viscosity of the binder is 100 to 30000 mPa·s; according to another embodiment, the viscosity of the binder is 3000 to 15000 mPa·s.

According to an embodiment of the present application, the pH value of the binder is 5 to 7.

The selection of a binder with the above-mentioned solid content, viscosity and pH value can better achieve the bonding performance of the binder, for example, it can be applied to different active materials, and it is also helpful to the thickening and dispersion of the slurry.

According to an embodiment of the present application, the binder is a polyvinylamine-type binder.

According to an embodiment of the present application, the binder further includes an SBR emulsion-type binder, and the addition amount of the SBR emulsion-type binder is 0 to 60 wt % of the total mass of the binder.

According to an embodiment of the present application, the peeling strength of the binder is 20 N/m or more, for example, 20 to 40 N/m.

The present application also provides a method for preparing the above-mentioned binder, and the method includes the following steps:
(1) add an amide-based monomer and an initiator to carry out free radical polymerization reaction; or mix an amide-based monomer and at least one of a hydrophilic monomer, a hydrophobic monomer, and an amphiphilic monomer, and add an initiator to carry out free radical polymerization reaction; and
(2) convert a resulting product of step (1) into a polyvinylamine-type polymer through Hoffman degradation reaction or hydrolysis reaction to prepare a binder including the polymer.

According to an embodiment of the present application, the amide-based monomer is selected from an acrylamide-based monomer or a N-vinylamide-based monomer (according to another embodiment, the amide-based monomer is N-vinylformamide or N-vinylacetamide).

According to the embodiment of the present application, the hydrophilic monomer, the hydrophobic monomer, and the amphiphilic monomer have the same definitions as above.

According to an embodiment of the present application, in step (1), the reaction is carried out under the protection of an inert gas, and the inert gas is high-purity nitrogen or argon.

According to an embodiment of the present application, in step (1), a temperature for mixing is, for example, room temperature.

According to an embodiment of the present application, in step (1), a temperature of the radical polymerization reaction is 30 to 100° C.; according to another embodiment, a temperature of the radical polymerization reaction is 40 to 80° C.

According to an embodiment of the present application, in step (1), the reaction is carried out under stirring conditions, and the stirring speed is 300 to 1000 rpm; according to another embodiment, the stirring speed is 500 to 800 rpm.

According to an embodiment of the present application, in step (1), the initiator is selected from at least one of potassium persulfate, ammonium persulfate, sodium persulfate, tetravalent cerium salt (ammonium cerium nitrate), potassium permanganate, sodium persulfate/sodium bisulfite, ferrous sulfate/hydrogen peroxide, ammonium persulfate/tetramethylethylenediamine, and ammonium persulfate/sodium sulfite, where sodium persulfate/sodium bisulfate, ferrous sulfate/hydrogen peroxide, ammonium persulfate/tetramethylethylenediamine, and ammonium persulfate/sodium sulfite represent the initiators used in combination respectively, which can be added one after another during use. The addition amount of the initiator is 0.1 to 2 wt % of the total mass of the comonomers.

According to an embodiment of the present application, step (2) specifically includes the following steps:

the polyacrylamide-type polymer is converted into polyvinylamine-type polymer through the Hoffman degradation reaction or the poly-N-vinylamide-type polymer is converted into polyvinylamine-type polymer through hydrolysis reaction.

Exemplarily, when the repeating unit shown in Formula 1 in the polymer is derived from (methyl)acrylamide, the polymer containing the following repeating unit (i.e., polyacrylamide-type polymer) is converted to the repeating unit shown in Formula 1 through Hoffman degradation reaction:

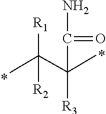

Exemplarily, in step (2), subjecting the polyacrylamide-type polymer in step (1) to the Hoffman degradation reaction specifically includes the following steps:

Mix the polyacrylamide-type polymer, sodium hydroxide (or potassium hydroxide), sodium hypochlorite, and water, stir, and react for 1 to 8 hours, and then add therein sodium hydroxide (or potassium hydroxide), stir and react for 5 to 18 hours, and finally, add 1 to 5 wt % of hydrochloric acid (or sulfuric acid) to neutralize until the pH is 7. The obtained product is added to methanol (or ethanol) solution to precipitate out, and the polyvinylamine-type polymer filter cake is obtained by suction filtration, and a solid powder is obtained after drying.

Wherein, in the first step, a ratio of substance amount (mole ratio) of sodium hydroxide (or potassium hydroxide)/sodium hypochlorite is 1/2 to 2/1, the mass of sodium hydroxide (or potassium hydroxide) is 0.5 to 5 times that of acrylamide monomer, and the amount of water is 10 to 80 times that of polyacrylamide-type polymer, and the temperature is −20 to −10° C.

Wherein, in the second step, the addition amount of sodium hydroxide (or potassium hydroxide) is 0.5 to 2 times that of the acrylamide monomer, and the temperature is 0 to 5° C.

Wherein, the stirring speed is 200 to 1000 rpm; according to another embodiment, the stirring speed is 500 to 800 rpm.

Wherein, the drying conditions are vacuum drying at 40 to 80° C., drying to constant weight.

Exemplarily, when the repeating unit shown in Formula 1 in the polymer is derived from an N-vinylamide-based monomer, the polymer containing the following repeating unit (i.e., poly-N-vinylamide-type polymer) is converted into the repeating unit shown in Formula 1 through hydrolysis reaction:

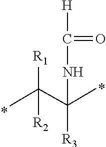

Exemplarily, in step (2), subjecting the poly-N-vinylamide-type polymer in step (1) to the hydrolysis reaction specifically includes the following steps:

Dissolve the poly-N-vinylamide-type polymer in water, add acid, use inert gas for protection, stir, and react for 8 to 16 hours. After the reaction is completed, add alkali to adjust the pH to 7. The obtained product is added to the methanol (or ethanol) solution to precipitate out, and the polyvinylamine-type polymer filter cake is obtained by suction filtration, and a solid powder is obtained after drying.

Wherein, the reaction temperature is 60° C. to 90° C.

Wherein, the stirring speed is 200 to 1000 rpm; according to another embodiment, the stirring speed is 500 to 800 rpm.

Wherein, the drying conditions are vacuum drying at 40 to 80° C., drying to constant weight.

[Application of the Binder]

As mentioned above, the present application also provides an application of the above-mentioned binder in a lithium-ion battery.

According to an embodiment of the present application, the above-mentioned binder is used as a binder in a positive electrode and/or a negative electrode of a lithium-ion battery.

According to another embodiment, the above-mentioned binder is used as a binder in the negative electrode of a lithium-ion battery.

[Electrode Piece]

As mentioned above, the present application provides an electrode piece including the above-mentioned binder.

According to an embodiment of the present application, the electrode piece includes a current collector and an active material layer located on a surface of at least one side of the current collector, the active material layer includes the above-mentioned binder.

According to an embodiment of the present application, the addition amount of the binder accounts for 0.5 to 5 wt % of the total mass of the active material layer, for example 0.8 to 2.5 wt %, for another example, 1.5 to 2.5 wt %.

According to an embodiment of the present application, the electrode piece includes a positive electrode piece or a negative electrode piece.

According to an embodiment of the present application, the negative electrode piece includes a negative electrode current collector and a negative electrode active material layer located on a surface of at least one side of the negative electrode current collector, the negative electrode active material layer includes the above-mentioned binder.

According to an embodiment of the present application, the negative electrode current collector is a single-sided glossy copper foil, a double-sided glossy copper foil or a porous copper foil.

According to an embodiment of the present application, the negative electrode active material layer also includes a negative electrode active material, a dispersant agent, and a conductive agent.

According to an embodiment of the present application, the negative electrode active material includes at least one of artificial graphite, natural graphite, mesophase carbon bead, and lithium titanate, silicon oxide, nano-silicon powder, silicon monoxide, silicon carbon, and silicon-doped graphite.

According to an embodiment of the present application, the dispersant agent is sodium carboxymethyl cellulose or lithium carboxymethyl cellulose.

According to an embodiment of the present application, the conductive agent is at least one of graphite, carbon black, acetylene black, graphene, and carbon nanotube.

Wherein, the amount of the binder and/or conductive agent is the amount known in the filed.

The present application also provides a method for preparing the above-mentioned negative electrode piece, and the method includes the following steps:

coating a surface of one or both sides of the negative electrode current collector with a slurry containing the above-mentioned binder to prepare the negative electrode piece.

According to an embodiment of the present application, the preparation method of the negative electrode piece includes the following steps:
(1) mixing a negative electrode active material, a conductive agent, the above-mentioned binder and a dispersant agent uniformly to obtain a negative electrode slurry; and
(2) coating the negative electrode slurry on a surface of a negative electrode current collector, and dying to obtain the negative electrode piece.

Wherein, the negative electrode piece includes a negative electrode current collector and a negative electrode active material layer on a surface of the negative electrode current collector.

According to an embodiment of the present application, the positive electrode piece includes a positive electrode current collector and a positive electrode active material layer located on a surface of at least one side of the positive electrode current collector, and the positive electrode active material layer includes the above-mentioned binder.

According to an embodiment of the present application, the positive electrode current collector is a single-sided glossy aluminum foil, a double-sided glossy aluminum foil or a porous aluminum foil.

According to an embodiment of the present application, the positive active material layer also includes a positive active material and a conductive agent.

According to an embodiment of the present application, the positive active material is at least one of lithium iron phosphate, ternary positive electrode material, and lithium cobaltate.

According to an embodiment of the present application, the conductive agent is at least one of graphite, carbon black, acetylene black, graphene, and carbon nanotube.

According to an embodiment of the present application, the preparation method of the positive electrode piece includes the following steps:
(1) mixing a positive electrode active material, a conductive agent, and the above-mentioned binder uniformly to obtain a positive electrode slurry; and
(2) coating the positive electrode slurry on a surface of the positive electrode current collector, and dying to obtain the positive electrode piece.

[Application of Electrode Piece]

The present application also provides an application of the above-mentioned electrode piece in a lithium-ion battery.

[Lithium-ion Battery]

As mentioned above, the present application provides a lithium-ion battery, which includes the above-mentioned binder.

According to an embodiment of the present application, the lithium-ion battery includes the above-mentioned electrode piece.

According to an embodiment of the present application, the lithium-ion battery is assembled from a positive electrode piece, a separator, a negative electrode piece and electrolyte. For example, the positive electrode piece, the negative electrode piece and the separator are assembled into a battery cell by winding or stacking which are commonly used in this industry, and encapsulated by aluminum laminated film, and then sequentially subjected to baking, injection with electrolyte, formation, and secondary encapsulation, to obtain a lithium-ion battery.

The preparation method of the present application will be further described in detail below in conjunction with specific examples. It should be understood that the following examples are merely illustrative description and explanation of the present application, and should not be construed as limiting the scope of protection of the present application. All technologies implemented based on the above content of the present application are covered within the protection scope of the present application.

The experimental methods used in the following examples are conventional methods unless otherwise specified; the reagents, materials, etc. used in the following examples are commercially available unless otherwise specified.

The viscosity involved in the following examples and comparative examples is measured using a digital display rotary viscometer (Shanghai Sannuo NDJ-5S) at room temperature (20 to 25° C.).

The glass transition temperature involved in the following examples and comparative examples is measured by a differential scanning calorimeter (DSC), with model 910s (TA Instruments, USA).

### Example 1

10 parts (by mass, same as below) of N-vinylformamide, 3 parts of sodium acrylate, and 165 parts of water were sequentially added to a reaction flask with nitrogen introduced for protection. The mixture was stirred at 300 rpm, and heated to 40° C. After continuously stirring for 20 minutes, 0.05 parts of sodium persulfate and 0.025 parts of sodium bisulfite were added, keeping the temperature at 40° C. and condensing, and then the mixture was stirred continuously at 300 rpm, and reacted for 7 h to obtain poly(N-vinylformamide-sodium acrylate) copolymer. The temperature was controlled to 25° C., 14 parts by mass of concentrated hydrochloric acid (37%) was added, and the mixture was stirred at 500 rpm, and reacted at 80° C. for 12 hours under protection of nitrogen. The temperature was lowered to 25° C., then 10% of sodium hydroxide was added to adjust the pH to 7, and finally 600 parts by mass of anhydrous methanol was added. After the polymer was precipitated, suction filtration was carried out and the filter cake was dried in a vacuum drying oven at 60° C. to obtain a polyvinylamine-type polymer (poly(vinylamine-sodium acrylate)) powder.

The prepared polyvinylamine-type polymer has a molecular weight of 640,000, a decomposition temperature of 315° C. (TG test), and a glass transition temperature of 163° C. (DSC test). The prepared polyvinylamine-type polymer powder was added with deionized water, stirred and dissolved to obtain a polyvinylamine-type binder, with a solid content of 7 wt % and a viscosity of 6800 mPa·s.

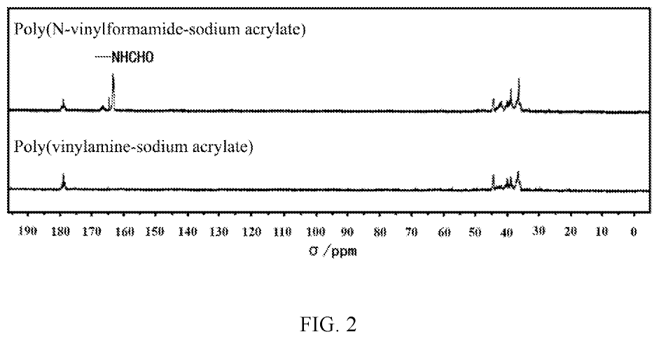

A ¹³CNMR spectrum of the prepared polyvinylamine-type polymer is shown in FIG. 2, where the carbon absorption peak in —NHCHO at 163.4 to 166.8 ppm disappears, which proves that the poly(N-vinylformamide-acrylic acid) underwent complete hydrolysis, resulting in the formation of poly(vinylamine-acrylic acid).

Lithium cobaltate as positive electrode active material, PVDF as binder and conductive carbon black were dispersed in N-methylpyrrolidone, and stirred to obtain an uniformly dispersed positive electrode slurry, where the solid components include 96.6 wt % of lithium cobaltate, 1.4 wt % of PVDF and 2 wt % of the conductive carbon black, the positive electrode slurry has a solid content of 64.5 wt %, and viscosity of 18746 mPa·s. The positive electrode slurry was evenly coated on both sides of the aluminum foil, dried at 100 to 130° C. for 4 hours, and compacted using a roller press with a compaction density of 2.5 to 3.1 g/cm³ to obtain a positive electrode piece.

Graphite, the above-mentioned polyvinylamine-type binder, CMC as dispersant agent and conductive carbon black as conductive agent were mixed and dispersed in deionized water to obtain a negative electrode slurry, where solid components include 96 wt % graphite, 0.5 wt % of CMC, 1.3 wt % of SBR emulsion from Zeon BM-480B, 0.5 wt % of conductive carbon black, 1.7 wt % of the above-mentioned polyvinylamine-type binder, the negative electrode slurry has a solid content of 44 to 46 wt %, and a viscosity of 6851 mPa·s. The slurry was evenly coated on both sides of a copper foil, dried at 70 to 100° C. for 5 h, and compacted by a roller press with a compaction density of 1.5 to 1.7 g/cm³ to obtain a negative electrode piece.

The positive electrode piece, the negative electrode piece and a separator (PP/PE/PP composite film, thickness of 8 μm, porosity of 42%) are wound and encapsulated to form a cell, and then injected with an electrolyte, formed, hot pressed, and secondarily encapsulated to obtain a lithium-ion battery.

### Example 2

10 parts (by mass, same as below) of acrylamide, 3 parts of sodium acrylate, and 150 parts of water were added to a reaction flask in sequence with nitrogen introduced for protection. The mixture was stirred at 300 rpm, and heated to 40° C. After continuously stirring for 20 minutes, 0.05 parts of ammonium persulfate and 0.03 parts of tetramethylethylenediamine were added, keeping the temperature at 40° C. and condensing, and then the mixture was stirred continuously at 300 rpm, and reacted for 7 h to obtain poly(acrylamide-sodium acrylate) copolymer. The temperature was controlled to −8° C., 8 parts by mass of sodium hydroxide and 12 parts by mass of sodium hypochlorite were added, and reacted for 2 h at 500 rpm under stirring. Then the temperature was increased to 0° C., and 8 parts of sodium hydroxide was added, and the reaction was continued for 12 h at 500 rpm under stirring. 2% of hydrochloric acid was added to adjust the pH to 7, and finally 600 parts by mass of anhydrous methanol was added. After the polymer was precipitated, suction filtration was carried out and the filter cake was dried in a vacuum drying oven at 60° C. to obtain a polyvinylamine-type polymer (poly(vinylamine-sodium acrylate)) powder.

The prepared polyvinylamine-type polymer has a molecular weight of 820,000, a decomposition temperature of 325° C. (TG test), and a glass transition temperature of 168° C. (DSC test). The prepared polyvinylamine-type polymer powder was added with deionized water, stirred and dissolved to obtain a polyvinylamine-type binder with a solid content of 8 wt % and a viscosity of 7500 mPa·s.

The process of the method for manufacturing the lithium-ion battery is basically the same as that of Example 1, except that the binder used is the polyvinylamine-type polymer binder synthesized in the present example.

### Example 3

10 parts (by mass, same as below) of acrylamide, 5 parts of sodium allyl sulfonate, 1 part of butyl acrylate, 0.05 parts of stearic acid polyoxyethylene ether acrylate, 160 parts of water were added into to a reaction flask in sequence with nitrogen introduced for protection. The mixture was stirred at 300 rpm, and heated to 65° C. After continuously stirring for 20 minutes, 0.05 parts of ammonium persulfate was added, keeping the temperature at 65° C. and condensing, and then the mixture was stirred continuously at 300 rpm, and reacted for 7 h to obtain poly(acrylamide-sodium allyl sulfonate-butyl acrylate-stearic acid polyoxyethylene ether acrylate) copolymer. The temperature was controlled to −9° C., add 8 parts by mass of sodium hydroxide, 12 parts by mass of sodium hypochlorite were added, and reacted for 2 h at 500 rpm under stirring. Then the temperature was increased to 0° C., and 8 parts of sodium hydroxide were added, and the reaction was continued for 12 h at 500 rpm under stirring. 2% of hydrochloric acid was added to adjust the pH to 7, and finally 600 parts by mass of anhydrous methanol was added. After the polymer was precipitated, suction filtration was carried out and the filter cake was dried in a vacuum drying oven at 60° C. to obtain a polyvinylamine-type polymer (poly(vinylamine-sodium allyl sulfonate-butyl acrylate-stearic acid polyoxyethylene ether acrylate)) powder.

The prepared polyvinylamine-type polymer has a molecular weight of 820,000, a decomposition temperature of 328° C. (TG test), and a glass transition temperature of 160° C. (DSC test). The prepared polyvinylamine-type polymer powder was added with deionized water, stirred and dissolved to obtain a polyvinylamine-type binder, with a solid content of 6 wt % and a viscosity of 9700 mPa·s.

The process of the method for manufacturing the lithium-ion battery is basically the same as that of Example 1, except that the binder used is the polyvinylamine-type polymer binder synthesized in the present example.

### Example 4

10 parts (by mass, same as below) of N-vinylformamide, 5 parts of sodium acrylate, 1 parts of hydroxyethyl acrylate, 0.05 parts of nonylphenol polyoxyethylene ether acrylate, and 160 parts of water were added into a reaction flask in sequence with nitrogen introduced for protection. The mixture was stirred at 300 rpm, and heated to 70° C. After continuously stirring for 20 minutes, 0.05 parts of potassium persulfate was added, keeping the temperature at 70° C. and condensing, and then the mixture was stirred continuously at 300 rpm, and reacted for 7 h to obtain a poly(N-vinylformamide-sodium acrylate-hydroxyethyl acrylate-nonylphenol polyoxyethylene ether acrylate) copolymer. The temperature was controlled to 25° C., 14 parts by mass of concentrated hydrochloric acid (37%) was added, stirred at 500 rpm under protection of nitrogen, and reacted at 80° C. for 12 h. The temperature was lowered to 25° C., 10% of sodium hydroxide was added to adjust the pH to 7, and finally 600 parts by mass of anhydrous methanol was added. After the polymer was precipitated, suction filtration was carried out and the filter cake was dried in a vacuum drying oven at 60° C. to obtain a polyvinylamine-type polymer (poly(vinylamine-sodium acrylate-hydroxyethyl acrylate-nonylphenol polyoxyethylene ether acrylate)) powder.

The prepared polyvinylamine-type polymer has a molecular weight of 680,000, a decomposition temperature of 337° C. (TG test), and a glass transition temperature of 165° C. (DSC test). The prepared polyvinylamine-type polymer powder was added with deionized water, stirred and dissolved to obtain a polyvinylamine-type binder with a solid content of 5.5 wt % and a viscosity of 7400 mPa·s.

The process of the method for manufacturing the lithium-ion battery is basically the same as that of Example 1, except that the binder used is the polyvinylamine-type polymer binder synthesized in the present example.

### Comparative Example 1

Compared with Example 1, the difference lies in that no Hoffman degradation is performed, and poly(N-vinylformamide-sodium acrylate) is directly used as the binder. The content and preparation process of other substances are the same as those of Example 1.

### Comparative Example 2

Compared with Example 2, the difference lies in that no hydrolysis is performed, and poly(acrylamide-acrylic acid) is directly used as the binder. The content and preparation process of other substances are the same as those of Example 2.

### Comparative Example 3

Compared with Example 3, the difference lies in that no hydrolysis is performed, and poly(acrylamide-sodium allyl sulfonate-butyl acrylate-stearic acid polyoxyethylene ether acrylate) is directly used as the binder. The content and preparation process of other substances are the same as those of Example 3.

### Comparative Example 4

Compared with Example 4, the difference lies in that no hydrolysis is performed, and poly(N-vinylformamide-sodium acrylate-hydroxyethyl acrylate-nonylphenol polyoxyethylene ether acrylate) is directly used as the binder. The content and preparation process of other substances are the same as those of Example 4.

### Comparative Example 5

Compared with Example 1, the difference lies in that 1.7 wt % of poly(vinylamine-sodium acrylate) as a binder is replaced with 0.7 wt % of SBR emulsion from Zeon BM-480B and 1 wt % of CMC glue. That is, the proportion of SBR emulsion is 2 wt %, and the proportion of CMC is 1.5 wt %, which are ratios of SBR emulsion and CMC glue commonly used in the field of lithium battery. The content and preparation process of other substances are the same as those of Example 1.

### Testing Example 1

The cycle capacity retention rate and expansion rate involved in the following examples and comparative examples were measured using the following method:

at room temperature of 25° C., performing a 0.5C/0.5C charge-discharge cycle for 250 times, the cycle capacity retention rate and expansion rate were calculated after 250 times.

The rate capability (rate discharge) involved in the following examples and comparative examples were measured using the following method:

discharge a fully charged battery to a cut-off voltage at 0.2C/0.5C/1.0C/1.5C/2.0C respectively, and calculate capacity retention rate (capacity retention rate compared to 0.2C discharge), namely the values of 0.5C/0.2C, 1.0C/0.2C, 1.5C/0.2C, 2C/0.2C.

The peeling strength involved in the following examples and comparative examples was obtained by using the following method:

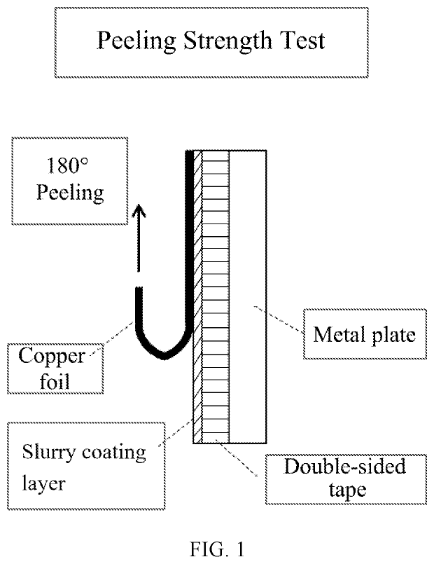

a negative electrode slurry is coated on a surface of a copper foil as current collector, dried and is subjected to cold press to form an electrode piece, the prepared electrode piece is cut into test specimens with a size of 20×100 mm, as standbys; one side of a double-sided tape is bonded to one side to be tested of an electrode piece specimen and compacted with a pressing roller to fully fit it with the electrode piece; the other side of the double-sided tape of the specimen is adhered to a surface of a stainless steel, and one end of the specimen is reversely bent at a bending angle of 180°; using a high-speed rail tensile machine for testing, one end of the stainless steel is fixed to a lower fixture of the tensile machine, and the bent end of the specimen is fixed to an upper fixture of the tensile machine; and an angle of the specimen is adjusted to ensure that the upper and lower ends thereof are in a vertical position, and then the specimen is stretched at a speed of 50 mm/min until the negative electrode slurry is completely peeled off from the substrate, and the displacement and action force during the process are recorded, and a force at force balance is considered to be the peeling strength of the electrode piece. The test device is as shown in FIG. 1.

TABLE 1
Performances of electrode pieces and batteries prepared
in the examples and the comparative examples

| | Peeling strength | Cycle Capacity | Expansion |
|---|---|---|---|
| | (N/m) | Retention Rate (%) | Rate (%) |
| Example 1 | 29 | 98 | 6.0 |
| Comparative | 15 | 90 | 9.1 |
| Example 1 | | | |
| Example 2 | 34 | 95 | 5.3 |
| Comparative | 14 | 91 | 8.6 |
| Example 2 | | | |
| Example 3 | 36 | 95 | 4.9 |
| Comparative | 17 | 89 | 8.9 |
| Example 3 | | | |
| Example 4 | 40 | 97 | 5.6 |
| Comparative | 13 | 90 | 7.8 |
| Example 4 | | | |
| Comparative | 20 | 92 | 10.1 |
| Example 5 | | | |

TABLE 2
The rate capacity of the batteries prepared in the examples and the comparative examples

| | | Compar- | | Compar- | | Compar- | | Compar- | Compar- |
|---|---|---|---|---|---|---|---|---|---|
| | | ative | | ative | | ative | | ative | ative |
| Item | Example 1 | Example 1 | Example 2 | Example 2 | Example 3 | Example 3 | Example 4 | Example 4 | Example 5 |
| 0.5 C/0.2 C | 95.9% | 91.4% | 96.2% | 91.2% | 95.8% | 91.6% | 96.4% | 91.8% | 90.6% |
| 1 C/0.2 C | 94.1% | 89.5% | 93.9% | 89.4% | 94.1% | 89.6% | 94.8% | 89.9% | 88.2% |
| 1.5 C/0.2 C | 90.2% | 83.7% | 90.3% | 82.6% | 89.5% | 85.2% | 90.2% | 87.3% | 83.1% |
| 2 C/0.2 C | 87.4% | 82.6% | 87.6% | 81.8% | 86.4% | 81.6% | 86.6% | 82.8% | 79.5% |

It can be seen from Table 1 and Table 2 that the peeling strength of the electrode pieces in Examples 1-4 using the binder according to the present application is higher than that in Comparative Examples 1-5. It is shown that the existence of a large number of free amino groups in the binder of the present application can provide strong hydrogen bonding and form an effective adhesive network, thereby greatly increasing the adhesive effect of the binder. From the cycling and rate capability of the battery, Examples 1-4 are also better than Comparative Examples 1-5. This is due to the better conductive network of the electrode pieces adhered by the polyvinylamine-type binder, and meanwhile, due to hydrogen bonding effect of the binder on copper foil, the adhesion to copper foil is improved, which makes the conduction of electrons smoother, thus improving the cycle performance and rate capability of the battery. The effective adhered network also has a certain inhibitory effect on the expansion of the cycled battery.

In addition, since SBR emulsion itself has low viscosity, it has no thickening and stable dispersion effect on the slurry. In practical applications, if the SBR emulsion is directly used to replace the binder of the present application, the prepared negative electrode slurry will have a low viscosity and the active material is prone to sedimentation, therefore, it must be used together with CMC, i.e., forming Comparative Example 5 of the present application. While the binder itself of the present application has a certain viscosity and are also able to function as a thickener and stabilizer.

In the foregoing, the examples of the present application have been explained. However, the present application is not limited to the above-mentioned examples. Any modification, equivalent replacement, improvement, etc. made within the spirit and principle of the present application should be included within the protection scope of the present application.

What is claimed is:

1. A binder, wherein the binder comprises at least one polymer, and the polymer comprises a repeating unit shown in Formula 1: 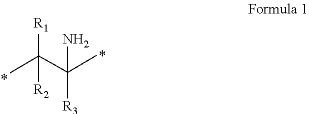
wherein, R₁, R₂, R₃ are the same or different, and are each independently selected from C₁₋₆ alkyl or hydrogen; and * is a connecting end.

2. The binder according to claim 1, wherein the polymer further comprises at least one of a repeating unit shown in Formula 2, a repeating unit shown in Formula 3, and a repeating unit shown in Formula 4: 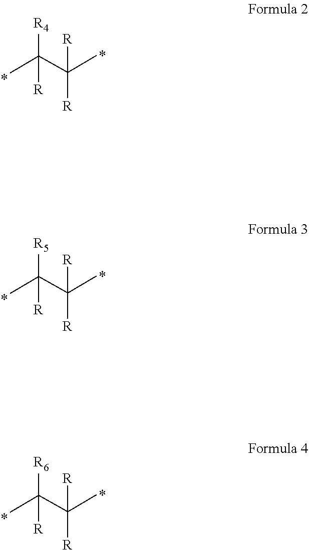
wherein, R₄ is a hydrophilic group, R₅ is a hydrophobic group, and R₆ is an amphiphilic group; each R is the same or different, and is independently selected from an organic group; and * is a connecting end.

3. The binder according to claim 2, wherein the repeating unit shown in Formula 2 is derived from a hydrophilic monomer; the repeating unit shown in Formula 3 is derived from a hydrophobic monomer; and the repeating unit shown in Formula 4 is derived from an amphiphilic monomer.

4. The binder according to claim 3, wherein the hydrophilic monomer comprises at least one of (meth)acrylic acid, butenoic acid, itaconic acid, maleic acid, (meth)acrylic salt, butenic salt, itaconic salt, maleic salt, sodium p-styrene sulfonate, sodium vinyl sulfonate, sodium allyl sulfonate, sodium 2-methallyl sulfonate, sodium 2-sulphonatoethyl methacrylate, hydroxyethyl (methyl)acrylate, hydroxypropyl (methyl)acrylate or dimethyl diallyl ammonium chloride.

5. The binder according to claim 3, wherein the hydrophobic monomer comprises at least one of methyl (meth)acrylate, ethyl (meth)acrylate, butyl (meth)acrylate, vinyl acetate, styrene, and acrylonitrile.

6. The binder according to claim 3, wherein the amphiphilic monomer comprises at least one of stearic acid polyoxyethylene ether (methyl)acrylate, nonylphenol polyoxyethylene ether (methyl)acrylate or dodecyl alcohol polyoxyethylene ether (methyl)acrylate.

7. The binder according to claim 2, wherein the polymer is a homopolymer formed by the repeating unit shown in Formula 1, or a copolymer formed by the repeating unit shown in Formula 1 with at least one of the repeating unit shown in Formula 2, the repeating unit shown in Formula 3 and the repeating unit shown in Formula 4.

8. The binder according to claim 7, wherein the repeating unit shown in Formula 2 accounts for 0 to 65 mol % of total moles of the copolymer; and/or the repeating unit shown in Formula 3 accounts for 0 to 20 mol % of the total moles of the copolymer; and/or, the repeating unit shown in Formula 4 accounts for 0 to 1 mol % of the total moles of the copolymer.

9. The binder according to claim 1, wherein the polymer has a weight average molecular weight of 400,000 to 10,000,000.

10. The binder according to claim 9, wherein the polymer has a weight average molecular weight of 800,000 to 3,000,000.

11. The binder according to claim 1, wherein the polymer has a decomposition temperature of 320 to 400° C., and a glass transition temperature of 120 to 200° C.

12. The binder according to claim 1, wherein a solid content of the binder is 0.1 to 10 wt %.

13. The binder according to claim 12, wherein the solid content of the binder is 0.3 to 5 wt %.

14. The binder according to claim 1, wherein a viscosity of the binder is 100 to 30000 mPa·s.

15. The binder according to claim 14, wherein the viscosity of the binder is 3000 to 15000 mPa·s.

16. The binder according to claim 1, wherein a pH value of the binder is 5 to 7.

17. The binder according to claim 1, wherein a peeling strength of the binder is 20 N/m or more.

18. A electrode piece, wherein the electrode piece comprises a current collector and a current collector and an active material layer located on a surface of at least one side of the current collector, the active material layer comprises the binder according to claim 1, and an addition amount of the binder accounts for 0.5 to 5 wt % of a total mass of the active material layer.

19. A lithium-ion battery, comprising the electrode piece according to claim 18.
